(19) United States
(12) Patent Application Publication
(10) Pub. No.: US 2012/0197583 A1
(43) Pub. Date: Aug. 2, 2012

(54) ELECTRONIC DEVICE AND METHOD FOR AUTOMATICALLY TESTING PRINTED CIRCUIT BOARDS

(75) Inventors: HSIEN-CHUAN LIANG, Tu-Cheng (TW); SHEN-CHUN LI, Tu-Cheng (TW); PO-CHUAN HSIEH, Tu-Cheng (TW); YU-CHANG PAI, Tu-Cheng (TW); SHOU-KUO HSU, Tu-Cheng (TW)

(73) Assignee: HON HAI PRECISION INDUSTRY CO., LTD., New Taipei (TW)

(21) Appl. No.: 13/290,143

(22) Filed: Nov. 7, 2011

(30) Foreign Application Priority Data
Jan. 28, 2011 (TW) 100103501

(51) Int. Cl. G06F 19/00

(52) U.S. Cl. 702/125

(57) ABSTRACT

A method of testing a printed circuit board (PCB) acquires test points from a wiring diagram of the PCB. Frequency domain tested items for each test point and a standard value of each frequency domain tested item are preset. A distance between a preset fiducial point and each test point is computed to create a testing order of the test points according to the distances. The frequency domain tested items of each test point are computed according to the testing order. A pass or a failure of each test point is displayed according to a determination of if each of the computed frequency domain tested items within the corresponding standard value, and a test result of the PCB is output according to the passes or the failures.

### BACKGROUND

1. Technical Field

Embodiments of the present disclosure relate to electronic devices and methods of signal testing, and more particularly to an electronic device and a method for automatically testing a printed circuit board (PCB).

2. Description of Related Art

PCBs are used in the construction of electronic devices. In the construction of an electronic device, a PCB is a place to mount electronic components and further provides means of electrical connections between the electronic components. Electrically-conductive traces, such as transmission lines, are used as one means to transmit electrical signals between the electronic components.

In transmissions via the transmission lines, the electrical signals may be weakened due to the poor quality or defects in the transmission lines. Thus, for achieving a better electrical signal quality, the PCB needs to be tested to determine whether all transmission lines in the PCB are good. Although the test of the PCB can be done by an engineer manually, this is troublesome and lengthy in terms of time.

### BRIEF DESCRIPTION OF THE DRAWINGS

FIG. 1 is a block diagram of one embodiment of an electronic device including a PCB testing system.

FIG. 2 is a block diagram of one embodiment of function modules of the PCB testing system of FIG. 1.

FIG. 3 is a flowchart of one embodiment of a method for automatically testing a PCB.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

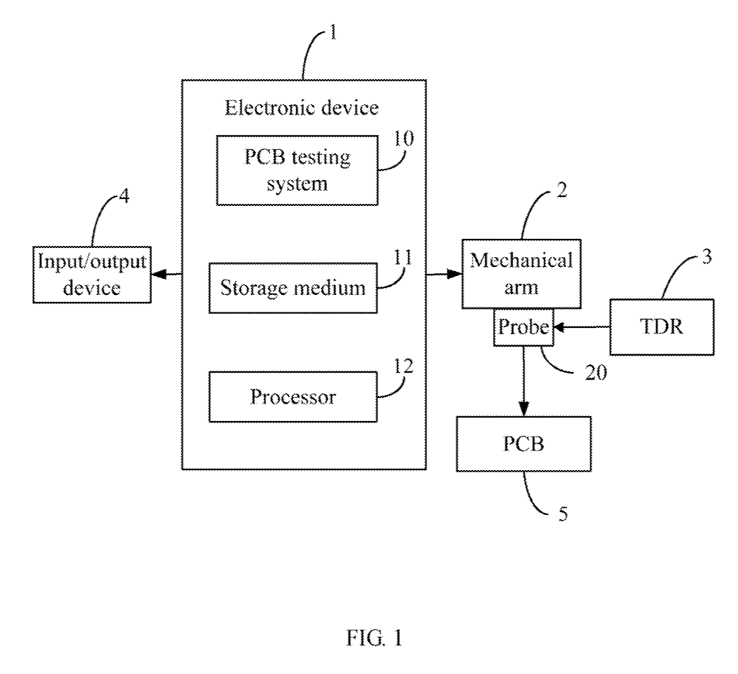

FIG. 1 is a block diagram of one embodiment of an electronic device 1 including a PCB testing system 10. In the embodiment, the electronic device 1 further includes a non-transitory storage medium (storage medium 11), and at least one processor 12. Depending on the embodiment, the storage medium 11 may be a hard disk drive, a compact disc, a digital video disc, a tape drive or other suitable storage medium.

The electronic device 1 is electronically connected to a mechanical arm 2 using a network (not shown). The network may be the Internet or an intranet. A probe 20 is positioned at a distal end of the mechanical arm 2, and is electronically connected to a time-domain reflectometer (TDR) 3. The mechanical arm 2 can be moved under the control of the electronic device 1, to position the probe 20 on a test point of a PCB 5, and enable the TDR 3 to obtain certain measured values of the test points using the probe 20. The measured values may be, such as TDR data and time-domain transmission (TDT) data. It may be understood that, the TDR 3 sends a square wave voltage to the PCB 5, and receives an electrical signal reflected from the PCB 5. The TDR data may include a voltage strength value of each time point during the electrical signal transmitting along a transmission line between the PCB 5 and the TDR 3, and the TDT data may include characteristic impendence values of the transmission line.

The electronic device 1 is further electronically connected to an input/output device 4, which can be a monitor, for example, used to display test interfaces and output test results.

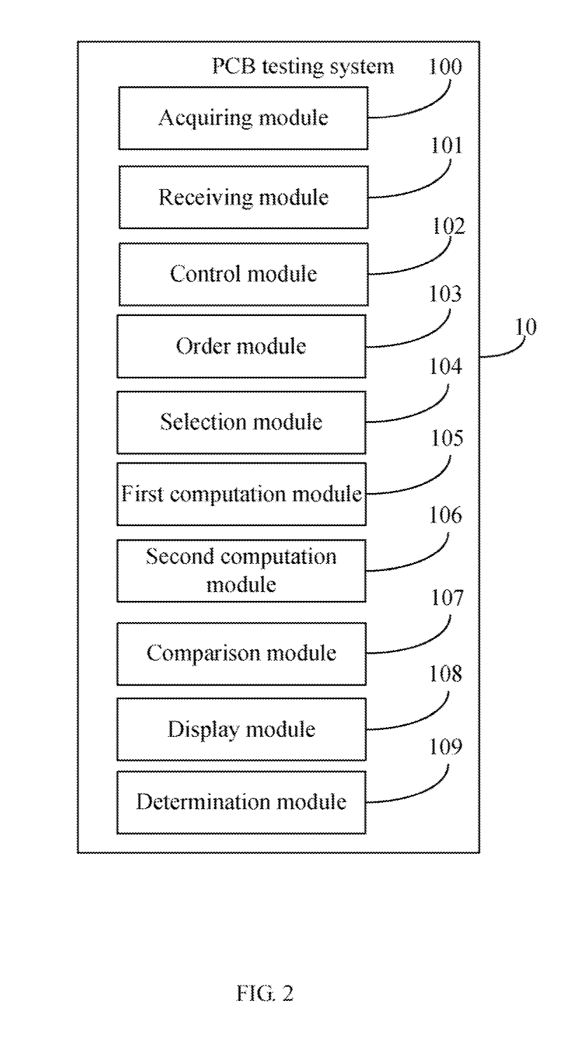

The PCB testing system 10 includes a number of function modules (depicted in FIG. 2). The function modules may comprise computerized code in the form of one or more programs that are stored in the storage medium 11. The computerized code includes instructions that are executed by the at least one processor 12, to automatically test the PCB 5 to determine whether transmission lines in the PCB 5 are in good and effective order, using the mechanical arm 2 and the TDR 3.

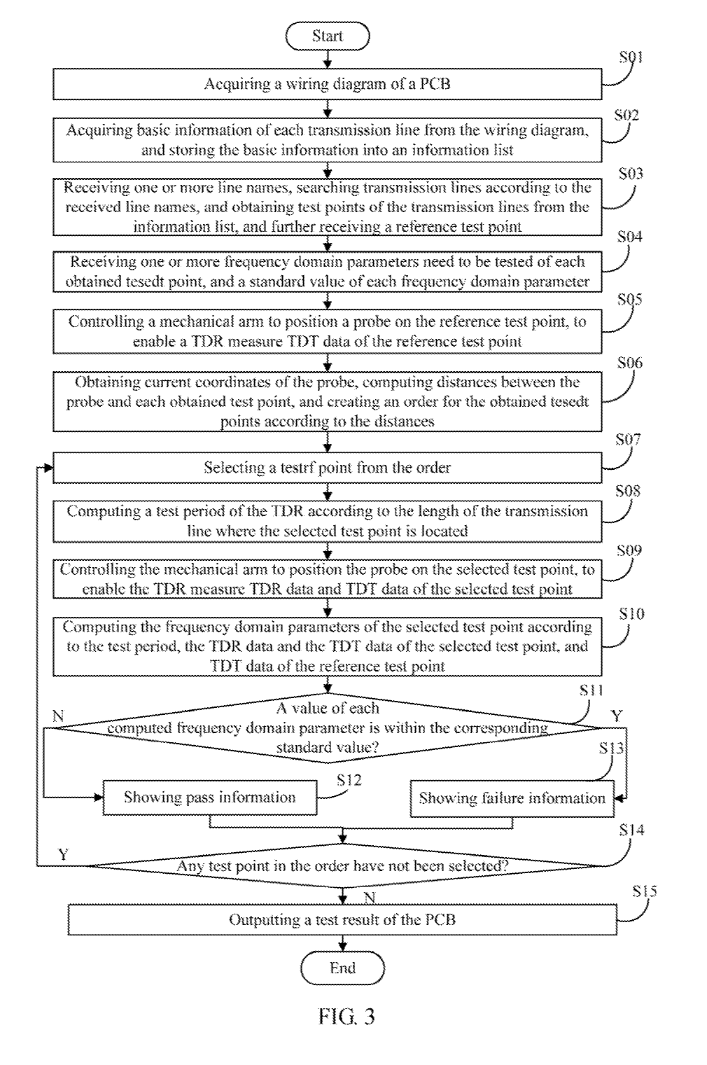

FIG. 2 is a block diagram of one embodiment of the function modules of the PCB testing system 10. In one embodiment, the PCB testing system 10 may include an acquiring module 100, a receiving module 101, a control module 102, a order module 103, a selection module 104, a first computation module 105, a second computation module 106, a comparison module 107, a display module 108, and a determination module 109. The function modules 100-109 may provide the below-mentioned functions (illustrated in FIG. 3).

FIG. 3 is a flowchart of one embodiment of a method for automatically testing a PCB. Depending on the embodiment, additional blocks may be added, others removed, and the ordering of the blocks may be changed.

In block S01, the acquiring module 100 acquires a pre-stored wiring diagram of the PCB 5 from the storage medium 11. The wiring diagram is an electronic file of a simplified conventional pictorial representation of an electrical circuit, in which multiple electrical components are wired together in sequence or in a ring(s) using transmission lines.

In block S02, the acquiring module 100 acquires basic information of each transmission line from the wiring diagram, and stores the basic information of the each transmission line into an information list. In one embodiment, the basic information of the each transmission line includes the name of the transmission line (line name), one or more test points on the transmission line, and the coordinates of the test points. The information list may be stored in the storage medium 11.

In block S03, the receiving module 101 receives one or more line names of the transmission lines from the input/output device 4, searches and obtains one or more test points on the transmission lines which correspond to the received line names from the information list, and further receives a reference test point from the input/output device 4. In one embodiment, the reference test point may be designated by a user. The reference test point is a point of a possible a short circuit location of the PCB 5.

In block S04, the receiving module 101 presets one or more frequency domain tested items for each of the obtained test points and presets a standard value for each of the frequency domain tested items via the input/output device 4. The frequency domain tested items may include, but are not limited to, insertion loss, return loss, and impedance.

In block S05, the control module 102 controls the mechanical arm 2 to position the probe 20 on the reference test point, to enable the TDR 3 to extract TDT data from the reference test point using the probe 20. As mentioned above, the TDT data may include characteristic impendence values of the transmission line between the TDR 3 and the reference test point.

In block S06, the order module 103 obtains the coordinates of a fiducial point(s), computes the distance between the fiducial point and each of the obtained test points, and creates a testing order for the obtained test points according to the distances computed. In one embodiment, the fiducial point or one of them is the starting position of the probe 20.

In block S07, the selection module 104 selects a test point according to the testing order established by block S06. The selected test point has not been selected before and is the one nearest to the fiducial point.

In block S08, the first computation module 105 computes the test period of the TDR 3 according to the length of the transmission line containing the selected test point. The test period is the total time spent by a pulse emitted from the TDR 3 in passing through the transmission line.

In block S09, the control module 102 controls the mechanical arm 2 to position the probe 20 on the selected test point, to enable the TDR 3 to function and gather TDT data and TDR data from the selected test point using the probe 20. As mentioned above, the TDR data may include a voltage strength value of each time point during an electrical signal transmitting along a transmission line between the TDR 3 and the selected test point, and the TDT data may include characteristic impendence values of the transmission line.

In block S10, the second computation module 106 computes the frequency domain tested items of the selected test point according to the test period, the TDT data and the TDR data of the selected test point, and the TDT data of the reference test point.

In block S11, the comparison module 107 compares a value of each of the computed frequency domain tested items with a corresponding standard value, and determines if the value of each of the computed frequency domain tested items is within the corresponding standard value. Block S12 is implemented if the value of each of the computed frequency domain tested items is within the corresponding standard value. Otherwise, block S13 is implemented if the value of any computed frequency domain tested item is not within the corresponding standard value.

In block S12, the display module 108 may displays pass information indicating that the selected test point passes the test, via the input/output device 4, or in block S13, the display module 108 may display failure information indicating that the selected test point failed the test via the input/output device 4.

In block S14, the determination module 109 determines if there is any test point in the testing order which has not been selected and tested. Block S07 is repeated if any test point in the testing order has not been selected and tested. Otherwise, block S15 is implemented if all the test points in the testing order have been selected and tested.

In block S15, the input/output device 4 outputs the test results of the PCB 5. If all test points in the PCB 5 have passed the tests above, the PCB 5 has good quality, or at least not defective, otherwise, if any test point in the PCB 5 fails the tests above, the PCB 5 has a poor quality, and may be rejected or repaired.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for testing a printed circuit board (PCB), comprising:
acquiring a wiring diagram of the PCB from a non-transitory storage medium, the wiring diagram comprising a plurality of transmission lines;
acquiring basic information of the transmission lines from the wiring diagram;
receiving one or more line names of the transmission lines from an input/output device, obtaining test points on the transmission lines that correspond to the lines names;
receiving a reference test point;
presetting one or more frequency domain tested items for each of the test points and presetting a standard value for each of the frequency domain tested items;
extracting time-domain transmission (TDT) data of the reference test point using a time-domain reflectometer (TDR);
obtaining coordinates of a preset fiducial point related to the test points, computing a distance between the fiducial point and each of the test points, and creating a testing order for the test points according to the computed distances;
selecting a test point from the testing order, and computing the test period of the TDR according to the length of the transmission line containing the selected test point;
gathering TDT data and TDR data of the selected test point using the TDR;
computing the frequency domain tested items of the selected test point according to the test period, the TDT data and the TDR data of the selected test point, and the TDT data of the reference test point;
determining if a value of each computed frequency domain tested item is within the corresponding standard value;
displaying pass information or failure information of the selected test point according to the determination via the input/output device; and
outputting a test result of the PCB to the input/output device according to the pass information or the failure information of all test points in the PCB.

2. The method according to claim 1, wherein the basic information is stored in an information list of the non-transitory storage medium, and comprises a line name of the transmission line, one or more test points on the transmission line, and the coordinates of the test points.

3. The method according to claim 1, wherein the reference test point is a point of a possible short circuit location of the PCB.

4. The method according to claim 1, wherein the frequency domain tested items comprise insertion loss, return loss, and impedance.

5. The method according to claim 1, wherein the TDR data of the selected test point comprises a voltage strength value of one or more time points of an electrical signal transmitting along a transmission line between the TDR and the selected test point, and the TDT data of the selected test point comprises characteristic impendence values of the transmission line.

6. The method according to claim 1, wherein the fiducial point is the starting position of a probe of a mechanical arm connected with the TDR.

7. An electronic device, comprising:
an input/output device;
a non-transitory storage medium;
at least one processor; and
one or more modules that are stored in the non-transitory storage medium; and are executed by the at least one processor, the one or more modules comprising instructions to:
acquire a wiring diagram of a printed circuit board (PCB) from the non-transitory storage medium, the wiring diagram comprising a plurality of transmission lines;
acquire basic information of the transmission lines from the wiring diagram;
receive one or more line names of the transmission lines from the input/output device, obtaining test points on the transmission lines that correspond to the lines names;
receive a reference test point;
preset one or more frequency domain tested items for each of the test points and preset a standard value for each of the frequency domain tested items;
extract time-domain transmission (TDT) data of the reference test point using a time-domain reflectometer (TDR);
obtain coordinates of a preset fiducial point relating to the test points, computing a distance between the fiducial point and each of the test points, and create a testing order for the test points according to the computed distances;
select a test point from the testing order, and computing the test period of the TDR according to the length of the transmission line containing the selected test point;
gathering TDT data and TDR data of the selected test point using the TDR;
compute the frequency domain tested items of the selected test point according to the test period, the TDT data and the TDR data of the selected test point, and the TDT data of the reference test point;
determine if a value of each computed frequency domain tested item is within the corresponding standard value;
display pass information or failure information of the selected test point according to the determination via the input/output device; and
output a test result of the PCB to the input/output device according to the pass information or the failure information of all test points in the PCB.

8. The electronic device according to claim 7, wherein the basic information is stored into an information list of the non-transitory storage medium, and comprises a line name of the transmission line, one or more test points on the transmission line, and coordinates of the test points.

9. The electronic device according to claim 7, wherein the reference test point is a point of a possible short circuit location of the PCB

10. The electronic device according to claim 7, wherein the frequency domain tested items comprise insertion loss, return loss, and impedance.

11. The electronic device according to claim 7, wherein the TDR data of the selected test point comprises a voltage strength value of one ore more time points of an electrical signal transmitting along a transmission line between the TDR and the selected test point, and the TDT data of the selected test point comprises characteristic impendence values of the transmission line.

12. The electronic device according to claim 7, wherein the fiducial point is the starting position of a probe of a mechanical arm connected with the TDR.

13. A non-transitory storage medium having stored thereon instructions that, when executed by a processor of an electronic device, causes the processor to perform a method for testing a printed circuit board (PCB), comprising:
acquiring a wiring diagram of the PCB from a non-transitory storage medium, the wiring diagram comprising a plurality of transmission lines;
acquiring basic information of the transmission lines from the wiring diagram;
receiving one or more line names of the transmission lines from an input/output device, obtaining test points on the transmission lines that correspond to the lines names;
receiving a reference test point;
presetting one or more frequency domain tested items for testing each of the test points and presetting a standard value for each of the frequency domain tested items;
extracting time-domain transmission (TDT) data of the reference test point using a time-domain reflectometer (TDR);
obtaining coordinates of a preset fiducial point relating to the test points, computing a distance between the fiducial point and each of the test points, and creating a testing order for the test points according to the computed distances;
selecting a test point from the testing order, and computing the test period of the TDR according to the length of the transmission line containing the selected test point;
gathering TDT data and TDR data of the selected test point using the TDR;
computing the frequency domain tested items of the selected test point according to the test period, the TDT data and the TDR data of the selected test point, and the TDT data of the reference test point;
determining if a value of each computed frequency domain tested item is within the corresponding standard value;
displaying pass information or failure information of the selected test point according to the determination via the input/output device; and
outputting a test result of the PCB to the input/output device according to the pass information or the failure information of all test points in the PCB.

14. The non-transitory storage medium according to claim 13, wherein the basic information is stored into an information list of the non-transitory storage medium, and comprises a line name of the transmission line, one or more test points on the transmission line, and the coordinates of the test points.

15. The non-transitory storage medium according to claim 13, wherein the reference test point is a point of a possible short circuit location of the PCB.

16. The non-transitory storage medium according to claim 13, wherein the frequency domain tested items comprise insertion loss, return loss, and impedance.

17. The non-transitory storage medium according to claim 13, wherein the TDR data of the selected test point comprises a voltage strength value of one or more time points of an electrical signal transmitting along a transmission line between the TDR and the selected test point, and the TDT data of the selected test point comprises characteristic impendence values of the transmission line.

18. The non-transitory storage medium according to claim 13, wherein the fiducial point is the starting position of a probe of a mechanical arm connected with the TDR.
